(19) United States
(12) Patent Application Publication
(10) Pub. No.: US 2009/0113199 A1
(43) Pub. Date: Apr. 30, 2009

(54) METHOD FOR AUTOMATIC INTEGRATION AND PERSISTENT STORAGE OF A PRIORI VOLATILE PERSONALIZING PARAMETERS.

(76) Inventor: Yves Gattegno, L'Hay les Roses (FR)

Correspondence Address: BROWDY AND NEIMARK, P.L.L.C.;624 NINTH STREET, NW, SUITE 300, WASHINGTON, DC, 20001-5303, US

(21) Appl. No.: 11/995,673

(22) PCT Filed: Jul. 6, 2006
(86) PCT No.: PCT/FR2006/001667

§ 371 Date: Jul. 15, 2008

(30) Foreign Application Priority Data
Jul. 13, 2005 (FR) 0507557

(51) Int. Cl. G06F 9/445

(52) U.S. Cl. 713/100

(57) ABSTRACT

The invention concerns a method for persistent storage of personalizing parameter values of at least one logical process of management of a priori volatile data characterized in that it consists in creating in a first step one or more insertions into one or more loading and/or initializing sequences of said logical processes of management of data to be personalized, of at least one logical sub-process of data management which reads the personalizing parameter values previously saved, each of the insertions being arranged in chronological order after the corresponding previously saved personalizing parameter values are accessible for reading, each of the insertions being arranged in chronological order before said values are integrated by said logical processes of management of data to be personalized, the logical sub-processes being capable of efficiently saving the personalizing parameter values which they process on non volatile data media, so as to integrate the modifications of said values upon subsequent readings.

The present invention relates to a method for customizing data placed in a computer, called customization parameters, a station-by-station or user-by-user customization allowing each of said data to be different. Said data are, before being used, written in a medium which does not allow persistent modifications, and then efficiently read from this medium.

The following terms will be used in the description and claims and will have the meaning set forth below:
non-volatile media: media for storing data which are not systematically deleted when the computer is stopped or started. These are the following media for example:
   set formed by the holder and magnetic diskettes
   set formed by the holder and magnetic disk (or a portion thereof)
   holder and rewritable opto-magnetic disks
   nonvolatile memories (NVRAM, flash memory)
   data server on a network (local network, Internet . . . )
volatile media: the media for storing data which are systematically deleted when the computer is stopped or started. For example, these are RAM (random access memory) memories.
a customization parameter (PP): these are parameters which by their nature are intended to be different, or even unique, from one machine to another or from one user to another. The customization parameters are generally taken into account by logical methods for handling data so as to customize said logical data handling methods. For example the following customization parameters may be mentioned:
   a machine account password in an authentication domain, for example “Machine Domain Account Password in Active Directory”. By default, this parameter regularly changes without any human intervention automatically
   the name of the computer
   the license of the logical data handling method for accessing a service on the network
   a parameter characterizing the fact that summertime is actually applied on the relevant computer
   the whole or a part of the files containing information specific to each computer, for example license files
   the whole or part of internal structures used by the operating system of the computer or by application logical data handling methods which the computer will be caused to execute. Typically portions of the “Windows” registry base such as the computer name
   the whole or part of one or more physical sectors of one or more hard disks accessible to the user
   a combination of the examples above
   etc. . . .
Physical representation of the customization parameters: the physical representation of the customization parameters is the set of bytes which contain the value of one customization parameter before it is read and actually taken into account. For example, the whole or part of a file on a non-volatile medium, a group of data sectors on a hard disk. the whole or part of an internal structure of the operating system such as one or more values in a key of the “Windows” registry base.
Windows registry base: an internal structure specific to operating systems of the “Windows” family, the physical representation of which is a set of bytes in random access memory. Said physical representation is duplicated at regular intervals in several data files always located on the system hard disk by design of the operating systems of the “Windows” family, so as to be read during a subsequent start-up of the computer in order to instantiate the physical representation of the “Windows” registry base when the latter does not yet exist.
System hard disk: a medium for recording and reading data used by the operating system, in particular for collectively storing files therein which make up the operating system and which contain the values of the parameters of said operating system. These media may be entirely or partly partitioned and protected for writing and/or reading. As an example, mention may be made of:
   hard disks (or partitions of hard disks)
   solid-state memories used and recognized by the operating system as hard disks,
   . . .
A protection mechanism against writing on non-volatile media: methods for making non-volatile media logically volatile. These write-protection mechanisms intercept and redirect in RAM or in a volatile buffer (for example a file storing written data during a session of the operating system, a file which is deleted at each beginning or end of session of the operating system), the whole or part of the data for which writing into the protected non-volatile medium is requested by the operating system or by the data handling logical application methods.
A logical method for handling data: a module placed in a computer, generally represented by a file or a group of sectors of a hard disk, containing instructions which the computer may execute. A “Master-Boot-Record (MBR)”, a “boot” sector, an operating system loader are logical data handling methods. An operating system kernel, a peripheral driver are logical data handling methods. A computer application contains at least one logical data handling method.

Presently, certain computers may be configured in such a way that they use write-protection mechanisms so that they may not record on a long-term basis, data of the customization parameter type. Among these types of computers, “thin client” type computers are notably found, which use an operating system and so-called “onboard” data handling logical application methods, and which by default, by design, are voluntarily always in the same status during each start-up of said computer. In other words, there is no intention of retaining the changes made to the customization parameters from one start-up to the next.

However, in certain cases, it is necessary to persistently customize data which must be different from one computer to another, such as the names of computers on the network, the activation codes of logical data handling methods, or which have to change periodically such as computer account passwords in an “Active Directory” domain, certain license keys for logical data handling methods, etc . . .

This generally often leads to shutting down the machine so that the manager authorized to change these data may do so, as operating systems generally require for security reasons that the machine be stopped and restarted.

Generally, it is known that in the microcomputers used today, the operating system, the logical application methods for handling data as well as the data specific to the users, are stored on a hard disk (either a real or emulated disk, on a flash memory for example) which is accessible by the central processing unit of the computer.

This hard disk is a both read- and write-accessible storage medium. Changes normally made on such a hard disk are retained from one start-up to the next. This allows customization of a computer platform, but this also allows long term changes and sometimes undesirably, in how the operating system and the logical data handling methods react and interact. For example, this allows malevolent logical data handling methods, such as viruses placed in a computer, to remain active, to increasingly infect components of the system and to propagate. This also allows a user to make changes in the parameterization of an operating system or of data handling logical application methods, sometimes in a dangerous way and which may lead to destabilization of the station until it becomes partially or totally unusable.

This is why many stations are crippled so as not to allow users to change data contained in the medium where the files required for booting the operating system and launching the data handling logical application methods are recorded. Among these stations, so-called “thin client” terminals are found which harbor an operating system and logical data handling methods for connecting to application servers. The files allowing these onboard elements of a logical data handling method (operating System and logical application methods for handling data) to be launched are generally stored on “Disk-On-Modules” or “Flash-Disks”, which in fact are flash memory (non-volatile memory) used by the computer instead of a hard disk and using a hard disk interface for communicating with the other components of the computer, so that these flash memories “logically” are hard disks for the computer. In this so-called thin client computer type, mechanisms are generally set into place for preventing permanent writes into the “system disk”. These are often write filters which redirect all the writes usually performed on the system disk into random access memory (therefore volatile memory).

The filtering or the protection which makes said writes volatile are therefore also applied to system data which have to be modified regularly, such as certain computer account passwords in an authentication domain, such as the “Active Directory or Novell Directory Service” or the value of the parameter characterizing the fact that the system time of the relevant computer takes into account the shift induced by summertime.

Today the steps required for making a non-volatile modification of one or more customization parameters are the following:

1. First start-up

2. Loading of the kernel of the operating system (the write filters are then enabled, making volatile certain non-volatile media)

a) Possible access to the physical representations of the customization parameters

b) Reading of the customization parameters (for example the parameter characterizing the fact that the system time of the relevant computer takes into account the shift induced by summertime is: FALSE) by the operating system

c) Use of the customization parameters previously read by the logical data handling methods

3. Manual suppression of the protection of the system hard disk by a competent and authorized operator by making the write-protection mechanisms inoperative

4. Shutdown

5. Start-up by the manager

6. Loading of the kernel of the operating system (the write filters are disabled, giving back to certain media their non-volatile character)

a) Possible access to the physical representations of customization parameters

b) Reading of the customization parameters by the operating system

c) Use of the customization parameters previously read (for example the parameter characterizing the fact that the system time of the relevant computer takes into account the shift induced by summertime is: FALSE) by the logical data handling methods

7. Manual modification of certain customization parameters (for example the parameter characterizing the fact that the system time of the relevant computer takes into account the device induced by summertime is: TRUE)

8. Manual reinstallation of the protection of the system hard disk

9. Command for shutting down the system

10. Shutdown

11. Start-up by a user

12. Loading of the kernel of the operating system (the write filters are enabled, making volatile certain non-volatile media)

a) Possible access to the physical representations of the customization parameters

b) Reading of the customization parameters (for example the parameter characterizing the fact that the system time of the relevant computer takes into account the shift induced by summertime is: TRUE) by the operating system

c) Use of the customization parameters previously read by the operating system

13. Manual modification of certain customization parameters (for example the parameter characterizing the fact that the system time of the relevant computer takes into account the shift induced by summertime becomes FALSE)

14. Command for shutting down the system

15. Shutdown

16. Restart-up by a user: identical with the preceding one. The modification of the customization parameters is lost, such as for example the parameter characterizing the fact that the system time of the relevant computer takes into account the shift induced by summertime remains TRUE.

The object of the present invention is to notably simplify the updating of the customization parameters and may even authorize a local or remote user to make persistent modifications of customization parameters depending on an authorization level and on the nature of the customization parameter.

By means of the invention, said customization and the modifications of customized data may be performed without having to manually change the data located on the storage media accessible to said computer and normally write-protected or without having to temporarily disable the write-protection mechanisms.

With the invention, it is further possible to make modifications in the configuration of an operating system used by several computers while retaining the customizations specific to each computer, for example in the case of deployment of a unique hard disk image over multiple computers, a deployment which may be carried out with logical data handling methods for hard disk duplication.

In order to solve the problems related to the required customizations of the stations, the system disks of which are write-protected, the managers of these stations often resort to tricks: the customized information is duplicated outside the storage write-protected space and subsequently reused by disabling the protection system and by manually or semi-automatically copying the customization parameters into the storage space where they will be read subsequently. By using this kind of system, a restart of the client station is generally necessary so that data such as computer names (“NetBIOS” names used for “Windows” networks, security information related to belonging to a domain, for example to the “Windows” domains called “Active Directory” or to the Novell domain called “NODS”) are taken into account.

In the same way, when a total update of the data contained in the storage medium containing the operating system or certain data handling logical application methods needs to be carried out (update of all the bytes of said storage medium), this updating is performed by disabling the write-protection mechanisms of said storage. Next, once the updating is carried out, the customization parameters have to be copied (re-imported is often the term used) to where they will be subsequently read by the logical data handling methods. And finally, the station has to be restarted so that the customizations are taken into account (this restarting may be performed when the protection mechanisms are again enabled).

Advantageously, with the method according to the invention it is possible to get rid of the problems caused by these techniques and to eliminate the whole or part of the steps required for taking the customization parameters into account, as well as for making the modifications persistent, sometimes automatic, of some of said parameters, selection of the parameters to be taken into account being possible. The invention is made up of components which are logical data handling methods with which the values of the customization parameters may be recovered from a non-volatile storage medium, for example:
a real or emulated hard disk on which writes are not volatile,
a partition of a real or emulated hard disk on which the writes are not volatile,
a data server accessible through a network,
a non-volatile memory (of the “flash” type for example).

Once they are recovered, said components again copy (write) said values of the parameters, at each start-up, into the locations of the “logic” storage medium where they will be read by the logical methods for handling data. Said recopying will be performed before said customization parameters are used (read) by said logical data handling methods. This recopying should therefore be able to be performed very early in the operating system loading process, sometimes even before the starting of said loading process (one then speaks of “Pre-OS” or “Pre-Boot” processes), sometimes by using a temporary buffer medium accessible in the computer start-up process extremely early, such as the random access memory of the computer.

Because the values of said parameters are systematically copied before their use, even in the case when the storage space is volatile, one advantageously gets rid of the constraints related to the restarts required for taking said parameters into account as well as to the customizations which require temporary disabling of the protection mechanisms which protect the storage space against writing.

Furthermore, the method according to the invention provides that upon switching off (or when the operating system is dumped before restarting) the machine which uses said invention, the values of the customization parameters are saved in a non-volatile storage space where they will again be read subsequently, so as to allow them to be actually modified if they have to be changed or renewed so that the operating system or the data handling logical application methods operate adequately. Said recopying on one or more non-volatile media may even be performed during a session of the operating system at a regular interval, so as to retain the modifications of the values even if the computer does not dump its operating system normally (for example in the case of an electrical power cut of the computer).

The object of the present invention is to find a remedy to the major drawbacks related to write-protection of storage media which contain the physical representation of the customization parameters, by proposing an original and specially well suited method allowing the taking into account and the updating of the customization parameters of a platform at the level of the loading and the initialization of at least one logical data handling method, said parameters being read from a logically volatile storage medium, i.e., which is such that any modification of a value of one of these parameters made by a user or a logical data handling method is lost during the shutdown or start-up procedure of said platform.

In a more specific way, the method according to the invention comprises the following steps:
1) First start-up
2) Loading the operating system
3) Loading the kernel of the operating system (the write filters are initially enabled, making volatile certain non-volatile media)
4) Possible access to the physical representations of the customization parameters
5) Reading of the customization parameters, generally read in the system hard disk (for example the parameter characterizing the fact that the system time of the relevant computer takes into account the shift induced by summertime is: FALSE) by the operating system
6) Use of the customization parameters previously read, by the logical data handling methods,
7) Manual suppression of the protection of the system hard disk by a competent and authorized operator, by making the write protection mechanisms inoperative.
8) Shutdown
9) Start-up by the manager
10) Loading the operating system
a) Loading the kernel of the operating system (the write filters are disabled, giving back to certain media a non-volatile character)
b) Possible access to the physical representations of the customization parameters
c) Possible reading of the customization parameters by the logical data handling methods,
d) The use of the customization parameters previously read, for example the parameter characterizing the fact that the system time of the relevant computer takes into account the shift induced by summertime is: FALSE, by the operating system
e) End of the loading of the operating system.
11) Making available to the user, the resources of the computer (for using or installing logical data handling methods for example, or for modifying certain parameters of the operating system (OS) or of the logical methods for handling data)
12) Installation and configuration of the logical sub-method (PROG-INJ) for handling injection data of the parameters in the configuration of the operating system so that it is launched at the right moment in the launch sequencing for the components of the operating system (OS) and of the logical data handling methods
a) selecting the customization parameters to be taken into account
b) selecting non-volatile media used by PROG-INJ for storing each customization parameter (the media are not all necessarily the same)
c) selecting the authorities entitled to change on a long-term basis each customization parameter (for example, only the “system” authority may be entitled to change on a long-term basis the value of the parameter characterizing the fact the system time of the relevant computer takes into account the shift induced by summertime)
13) manual reinstallation of the protection of the system hard disk
14) command for shutting down the system
15) shutdown
16) start-up by a user
17) loading the operating system
a) loading the kernel of the operating system, the write filters are enabled, making certain non-volatile media, volatile, where the relevant customization parameters (PPs) are recorded.
b) possible access to the physical representations of the previously saved customization parameters
c) automatically loading the logical data handling PROG-INJ sub-method and
d) reading values of the previously saved PPs, if any exist, in a provided media different from the one normally used by logical data handling methods which will take said PPs into account. For example, PROG-INJ reads the value of the parameter characterizing the fact that the system time of the relevant computer takes into account the shift induced by summertime, and this value is FALSE
e) no action is performed if the values of the PPs do not exist and one passes to step 18 directly
f) recopying by PROG-INJ of the values of the previously read PPs (for example the values of the parameter characterizing the fact that the system time of the relevant computer takes into account the shift induced by summertime, a value which is FALSE) instead of the values of the PPs which the operating system or the logical data handling methods will themselves read later on
g) reading and possible use of the values of the customization parameters (for example the value of the parameter characterizing the fact that the system time of the relevant computer takes into account the shift induced by summertime, a value which has the value FALSE) by the operating system and the logical data handling method
h) end of the loading of the operating system
18) making available to the user, the resources of the computer (for using or installing logical data handling methods for example, or for modifying certain parameters of the operating system (OS) or of the logical data handling methods)
19) automatic or manual modification of certain customization parameters (for example the value of the parameter characterizing the fact that the system time of the relevant computer takes into account the shift induced by summertime becomes: TRUE)
20) command for shutting down the system
21) the logical data handling sub-method PROJ.INJ, having remained enabled, recopies, if the constraints related to the authority having made each modification, authorize it, the new values of the PPs which it processes, for example the value (TRUE) of the parameter characterizing the fact that the system time of the relevant computer takes into account the shift induced by summertime, on a different and non-volatile medium assigned by PROG-INJ for each PP
22) “Loss” of the new values of the PPs (for example the value of the parameter characterizing the fact that the system time of the relevant computer takes into account the shift induced by summertime) from the random access memory (RAM) or from the volatile buffer
23) shutdown
24) new start-up by a user: identical with the previous one. The modification of the customization parameters is retained such as for example the value (TRUE) of the parameter characterizing the fact that the system time of the relevant computer takes into account the shift induced by summertime, a preserved value. This value is maintained and has become logically non-volatile.

According to the invention, the method consists in creating persistent storage of customization parameters which would otherwise be read and “written” in a medium for storing volatile data and the modifications of which would consequently be lost during restarting up the station, the method according to the invention describes a method which allows automatic taking into account and automatic updating of the values of some of the customization parameters of a platform at the level of the loading, initialization and switching-off procedures for at last one logical data handling method, the values of said parameters being stored by default on a storage medium in a non-writable way, i.e., when they are such that without the use of the invention, any modification of the value of one of these parameters performed by a user or a logical data handling method is lost during the shutdown procedure or start-up procedure of said platform,

characterized in that it consists in creating in a first step one or more insertions in one or more sequences for loading and/or initializing said logical data handling method(s), at least one logical data handling sub-method (called PROG-INJ here) which recovers the value(s) of the previously duplicated customization parameter(s),

each of the insertions being placed in chronological order after the customization parameter(s) to be modified is(are) write accessible,

each of the insertions being placed in chronological order before said customization parameter(s) is(are) taken into account by said logical method(s) for handling data to be customized, such said logical data handling method(s) PROG-INJ reading said pre-selected customization parameter(s) on at least one medium which is accessible to it or to them, where the value(s) of said customization parameter(s) has(have) been written beforehand (saved), such parameter(s) being then copied instead of the customization parameter(s) actually used by the logical data handling method(s), and then subsequently used by the logical data handling method(s) instead of the customization parameter(s) actually used by the logical data handling method(s).

Advantageously and always according to the invention

the saved customization parameter(s) are recorded on a non-volatile storage medium

the saved customization parameter(s) are read from a non-volatile storage medium

the saved customization parameter(s) are read from the random access memory of the computer

the method may comprise the following sequence
loading a specific module (a logical data handling sub-method) of the “PRE-OS” type, for example a “NETWORK BOOT PROGRAM PXE” or a module for which the loading and initialization are carried out by methods used for loading and initializing the “Master Boot Record” or “Boot-Sectors”
   after start-up by the user
   and before loading the operating system
executing said module immediately after having loaded it, said module containing all the means required for accessing the non-volatile medium containing the backup of the selected customized parameter(s). Execution is carried out by:
reading the value(s) of the previously saved customization parameter(s) from the selected non-volatile medium,
copying said value(s) of the customization parameter(s) into the random access memory of the platform,
setting up a “MEMRETR” mechanism with which the customization parameter(s) may again be found in the memory, for example a “magic” element which enables the beginning of the memory area to be found, used for storing the customization parameter(s) in memory,
setting up a mechanism making the memory area used for storing the customization parameter(s), unavailable to the logical data handling method(s),
launching the loading of the operating system, for example by executing a logical data handling sub-method of the “Master Boot Record (MBR,)” type or by executing a loader of the operating system
the operating system (OS) automatically loading the installed logical data handling sub-method (PROG-INJ)
PROG-INJ reading the customization parameter(s) if any exist, in random access memory by using the MEMRETR mechanism
PROG-INJ carrying out no action if the saved values of the customization parameters do not exist
PRG-INJ copying the values of the PPs read in the random access memory instead of the actual values of the selected PPs

said customization parameter(s) comprises(comprise) at least one structure containing the machine account password in an authentication domain

the non-volatile storage medium is a partition of a real or emulated hard disk

the selection of the non-volatile medium used by the logical data handling sub-method PROG-INJ depends on the customization parameter(s) taken into account by the logical data handling sub-method PROG-INJ

several platforms are grouped together each using a hard disk which has been duplicated from a same “Master” source, and where certain customization parameters have to be modified so that all these machines may operate together, for example in a same network, and where at least one procedure as described earlier is applied on each platform so that each platform includes certain customization parameters which are specific to it.

the customization parameter(s) contain the customization parameters controlling the execution of PROG-INJ

the customization parameter(s) controlling the execution of PROG-INJ are addresses of data required for executing PROG-INJ

actual saving of the customization parameters processed by PROG-INJ is performed when PROG-INJ receives a shut-off notification (for example a shut-off notification from the OS)

actual saving of the customization parameters processed by PROG-INJ is performed at regular intervals, so as to save the modified parameters even if no shut-off notification has been received by PROG-INJ (the case of power cuts or reset type halts)

saving the customization parameters processed by PROG-INJ is actually performed if the customization parameter was modified and if PROG-INJ is parameterized for saving the modifications on said parameter when they are made from a certain authority. For example, the machine name parameter may actually be saved by PROG-INJ only if the modification was made by a user of the “manager” or “super-user” group and not if it was made by a user of the group “users without manager privileges”. The authorities taken into account will for example be the Manager(s), the Operating System, Normal Users (other authorities may be taken into consideration)

the process for saving a particular parameter is launched as soon as the PROG-INJ detects that said parameter was changed, for example this detection may apply interprocess signal mechanisms, event detection mechanisms (for example by using the “RegNotifyChangeKeyValue” of the “Windows API”) etc.

This method is well suited for modifying certain customization parameters in an effective way especially in an environment comprising a set of several platforms each having a non-volatile storage medium which was duplicated from a same “Master” source, made logically volatile by write protection mechanisms and for which certain customization parameters have to be modified so that all these platforms may operate together in a same local network. However many other applications exist which naturally derive from the present invention.

Another exemplary embodiment according to the invention comprises the systems and methods which allow automatic configuration and persistent storage of the values of the customized parameters which are a priori detected by write-protection mechanisms. Such customized parameters are used by a logical data handling method for its customization. In certain embodiments, the relevant logical data handling method is part of the operating system, is a component of the operating system. The customized parameters include, but are not limited thereto, the parameters modified by a user or a logical data handling method, the values of which are a priori lost during the sequential procedures for shutting down or starting up an automated system.

Specific examples of the customized parameters include, but are not limited thereto, information belonging to an authentication domain, client licenses for accessing a service of the “Terminal Server (TS Calls)” type, serial numbers depending on each client machine, data depending on the hardware, etc. Whereas the systems known in the prior art allow persistent storage in memory of certain of these parameters, in many cases, such parameters are a priori protected by write-protection mechanisms. For example, the case may be considered, in which the operating system forms the whole or part of a portion of an image of a hard disk (a file which contains the byte-per-byte copy of the contents of a hard disk). Every time a client station is connected, it downloads this image from the server on a network. The system is configured in such a way that the client is not entitled to modify this image from the server on a long term basis. For this reason, any change made in the “client image” does not persist when the client is restarted and/or switched off. In certain applications, the present invention is used in a “client/server” environment in which the operating system of the client station is stored in an image itself stored on a server and downloaded on one or more clients when such clients are switched on. This image may not be directly modified by the client stations and generally is therefore always the same every time a client station recovers it. With the present invention, it is possible to make the storage of certain parameters persistent in such situations in order to allow customization of the specific installation and at the same time, to benefit from the advantages provided by the protection of the image. In other exemplary embodiments, the logical data handling method is the whole or part of an operating system comprised in an image. The whole or part of the customized parameters associated with the operating system is write-protected so that any modification made to such parameters is lost when the client computer is switched off and/or restarted.

According to other embodiments, the present invention is used in a client/server environment where the operating system is recorded in an image on a server, which is downloaded on one or more clients when such clients are switched on. The present invention is particularly advantageous for these embodiments because it allows persistent customization of the operating system and/or of other logical data handling methods, contained in the image stored on the server.

One of the purposes of the persistent storage facility of certain parameters according to the present invention is to take into account modifications of the customized parameters so that they may be picked up during subsequent execution by an automated logical data handling process in the loading and/or initialization step of said process.

According to other embodiments, the systems and the methods of the present invention provide an inventive device for persistent storage by executing a specific logical data handling method which applies at least one of the processes described in the present invention, before the whole or part of the logical method for handling data to be customized has been loaded. According to other embodiments, the persistent data are recorded so as to be accessible to the specific method. For example, according to other embodiments, the persistent data are recorded as one or more respective customized parameters and, for each respective customized parameter, there is a match with one or more insertions (an insertion is a saving of a value read and subsequently recopied therein where it will be used later on). Such insertions may be carried out in chronological order. As such, according to other embodiments, each respective insertion is placed in chronological order after the previously saved matching value of the customized parameter is read-accessible from the medium where it was saved earlier. According to other embodiments, each insertion is placed in chronological order after the matching value of the customized parameter is write-accessible in the medium where it will be written subsequently. According to other embodiments, each insertion is placed in chronological order before the customization parameters are taken into consideration by the automated logical data handling method, which should be customized and/or individualized.

According to other embodiments, the customized parameter(s) are saved on at least one medium accessible to the specific method which reads such parameters. In a client/server environment, such customized parameters may be recorded on the client, on the server, or on any computer accessible by the client and the server.

According to other embodiments, the values of the previously saved customized parameters are copied instead of the pre-existing values before initialization of the automated logic method for handling data to be customized. The logical method for handling data to be customized is then executed by using in fact the corresponding inserted values.

According to other embodiments, the values of the customized parameters are saved on non-volatile information media. According to other embodiments, the values of the customized parameters are read from non-volatile information media before deleting the values of the customized parameters read by the logical data handling method in order to be able to be used later on by the logical method for handling data to be customized. According to other embodiments, the saved values of the customization parameters are read from the memory of the random access memory (RAM) of a computer.

An aspect according to the invention shows a logical process for processing data which may be used in conjunction with a hardware computer system, a physical representation of the instructions of the process being located on a storage medium legible by the computer hardware system through the intervention of a suitable mechanism. The logical process for processing data comprises instructions encoding methods identified as one or more instructions which are executable by a computer. Another aspect according to the invention is the use of a computer system in order to facilitate any of the methods and processes identified above. The computer hardware system comprises a central processing unit and a memory, coupled with the central processing unit. the memory may contain instructions encoding methods identified from each other as one or more computer executable instructions.

Logical process for processing data: the present invention may be applied as a logical device for processing data, a device, a physical representation of the instructions of which may be recorded on a medium legible by a computer. For example, the logical process for processing data may contain the processes described above. Physical representations of the instructions of these processes may be recorded on a CDROM, a DVD, a magnetic disk memory device, or any other computer-legible device. The physical representations of the instructions of these processes may also be distributed electronically via Internet or otherwise, by transmitting a computer data signal (wherein said physical representations are present) either digitally or in an analog way, on a carrier wave for example.

Modifications and alternatives: many modifications and alternatives of this invention may be achieved without departing from its spirit or its scope, as this will be apparent to one skilled in the art. The specific embodiments described herein are shown only as an example, and the invention should only be limited by the limits of the claims, while observing the full range of the equivalents to which such claims entitle.

1. A method for automatically taking into account and persistently storing customization parameters of a platform which are protected against any modification by write-protection mechanisms, or customization parameters which are such that any modification of the value of one of these parameters made by a user or a logical data handling method is lost during the shutdown procedure or startup procedure of said platform, in order to take into account the update of the values of the customization parameters of logical data handling methods of said platform at the loading and initialization level of at least one data handling logical method, said method comprising a first step of creating of one or more insertions in one or more loading and/or initialization sequences of said logical data handling method(s), of at least one logical data handling sub-method (PROG-INJ) which reads the value(s) of the customization parameter(s) recorded beforehand,
each of the insertions being placed in chronological order after the value(s) of the corresponding customization parameter(s) saved beforehand is(are) read-accessible,
each of the insertions being in chronological order after the value(s) of the customization parameter(s) to be modified is(are) read-accessible in the medium where it (they) will be read subsequently,
each of the insertions being placed in chronological order before said customization parameter(s) is(are) taken into account by said logical method(s) for handling data to be customized, said logical data handling method(s) PROG-INJ reading the value(s) of the pre-selected customization parameter(s) on at least one medium which is accessible to it whereon the backup(s) of the value(s) of said customization parameter(s) has(have) been written beforehand, such value(s) being copied instead of the value(s) of the customization parameter(s) actually used by the logical data handling method(s) and then read and used by the logical data handling method(s) instead of the value(s) of the customization parameter(s) actually used by the logical method(s) for handling data to be customized,
said logical data handling method(s) PROG-INJ saving the value(s) of the pre-selected customization parameter(s) on at least one non-volatile storage medium.

2. The method according to claim 1 wherein the value(s) of the saved customization parameter(s) is(are) recorded on a non-volatile storage medium.

3. The method according to claim 1 wherein the value(s) of the saved customization parameter(s) is(are) read from a non-volatile storage medium before being copied instead of the value(s) of the customization parameter(s) actually used by the logical data handling method(s).

4. The method according to claim 2 wherein the saved customization parameter(s) are read from the random access memory of the computer.

5. The method according to claim 4 comprising the following sequence
loading a specific logical data handling sub-method of the “PRE-OS” type (PreOS-Module)
after start-up by the user
and before loading the operating system
execution of the PreOS-Module immediately after having loaded it, the PreOS-Module containing all the means required for accessing the non-volatile medium containing the backup of the value(s) of the selected customized parameter(s) by
reading the value(s) of the customization parameter(s) from the selected non-volatile medium,
copying said value(s) of the customization parameter(s) into the random access memory of the platform,
setting up a “MEMRETR” mechanism which allows the value(s) of the customization parameter(s) to be found again in the memory, as a “magic” element which allows characterization of the beginning of the memory area used for storing the value(s) of the customization parameter(s) in memory,
setting up a mechanism characterizing as occupied, and therefore right inaccessible for the logical methods for handling data other than PreOS-Module, the memory area used for storing said value(s)
launching the loading of the operating system, for example by executing a logical sub-method for handling data of the “Master Boot Record (MBR)” type or by executing an operating system loader
the operating system (OS) automatically loading the installed logical data handling sub-method (PROG-INJ)
said PROG-INJ submethod reading the value(s) of the customization parameter(s) if any exist, in the random memory by using the MEMRETR mechanism
said PROG-INJ submethod performing no action if no customization parameter value exists in random access memory
said PROG-INJ submethod copying the value(s) of the customization parameter(s) read in the random access memory instead of the value(s) of the selected customization parameter(s).

6. The method according to claim 1 wherein said customization parameter(s) comprises(comprise) at least one structure containing the machine account password in an authentication domain.

7. The method according to claim 2 wherein the non-volatile storage medium is a partition of a real or emulated hard disk.

8. The method according to claim 1 wherein the selection of the non-volatile medium used by the logical data handling sub-method PROG-INJ depends on the customization parameter(s) taken into account by the logical data handling sub-method PROG-INJ.

9. The method according to claim 1 wherein several platforms are grouped together each using a real or emulated hard disk which has been duplicated from a same “Master” source, and where certain customization parameters are modified so that all these machines may operate together, and so that each platform includes certain customization parameters which are specific to it.

10. The method according to claim 1, wherein the customization parameter(s) contain customization parameters controlling the execution of said submethod of PROG-INJ, in particular the characterization of the customization parameters to be taken into account.

11. The method according to claim 10, wherein the customization parameter(s) controlling the execution of PROG-INJ are addresses of data required for executing said submethod PROG-INJ.

12. The method according to claim 1, wherein saving of the value(s) of customization parameter(s) on a non-volatile data storage medium is performed when said submethod PROG-INJ receives a shut-off notification.

13. The method according to claim 1, wherein saving the value(s) of the customization parameter(s) on a non-volatile data storage medium is performed by said submethod PROG-INJ at regular intervals.

14. The method according to claim 1, wherein the actual saving process for a particular parameter is launched as soon as said submethod PROG-INJ detects that said parameter was modified.

15. The method according to claim 1, wherein the actual saving of a particular parameter depends on the fact that it has actually been modified and on the authority under which it was modified.
